(19) United States
(12) Patent Application Publication
(10) Pub. No.: US 2013/0076199 A1
(43) Pub. Date: Mar. 28, 2013

(54) ROTOR FOR ROTARY ELECTRIC MACHINE, AND ROTARY ELECTRIC MACHINE THAT USES THE ROTOR

(71) Applicant: Yoshitada Yamagishi, Toyota-shi (JP)

(72) Inventor: Yoshitada Yamagishi, Toyota-shi (JP)

(73) Assignee: TOYOTA JIDOSHA KABUSHIKI KAISHA, Toyota-shi (JP)

(21) Appl. No.: 13/612,329

(22) Filed: Sep. 12, 2012

(30) Foreign Application Priority Data
Sep. 28, 2011 (JP) 2011-212491

(51) Int. Cl. H02K 1/28

(52) U.S. Cl. 310/216.121

(57) ABSTRACT

A rotor for a rotary electric machine includes: a rotor shaft that is rotatably supported; and a rotor core that has a shaft hole in a central portion of the steel sheet stack, and that is tightened and fixed by thermal shrink fitting to a periphery of the rotor shaft inserted in the shaft hole, and that is made up of a stack of steel sheets. The rotor shaft has a reduced-interference portion at a position that corresponds to an end region of the rotor core in an axis direction of the rotor core, in a contact region of the rotor shaft which contacts an inner peripheral portion of the shaft hole of the rotor core.

### INCORPORATION BY REFERENCE

The disclosure of Japanese Patent Application No. 2011-212491 filed on Sep. 28, 2011 including the specification, drawings and abstract is incorporated herein by reference in its entirety.

### BACKGROUND OF THE INVENTION

1. Field of the Invention

The invention relates to a rotor for a rotary electric machine and, particularly, to a rotor for a rotary electric machine which has a construction in which a rotor core made up of a stack of steel sheets is fixed to a rotor shaft by thermal shrink fitting.

2. Description of Related Art

There is known a rotary electric machine that includes a rotor having a construction in which a rotor core made up of a steel sheet stack is fixed to an outer periphery of a rotor shaft that is rotatably supported, and a stator provided around the rotor with a predetermined space provided between the stator and the rotor.

Generally, the aforementioned rotor core is constructed by stacking many sheets punched out from thin magnetic steel sheets and firmly connecting the punched-out sheets together by swaging, welding, etc. Furthermore, a central portion of the rotor core is provided with a shaft hole that extends through the rotor core in an axis direction of the rotor core which coincides with the stacking direction of the steel sheets. The rotor core is fixed to the rotor shaft by inserting the rotor shaft through the shaft hole of the rotor core.

For example, Japanese Utility Model Application Publication No. 61-65839 (JP 61-65839 U) discloses an electric motor in which a rotator is formed by inserting a shaft through stacked steel sheets by press-in fitting, and in which each stacking steel sheet is provided with a recess on one side and a protrusion on the opposite side and the stacking steel sheets are stacked so that adjacent steel sheets are fitted to each other, and in which an approximately ½-to-¼ portion of the penetrating portion of the shaft that penetrates through the rotor core is tapered. According to the publication JP 61-65839 U, in this electric motor, since the shaft is provided with a taper that becomes narrower in the direction in which the shaft is inserted through the stacked steel sheets, the force needed to press the shaft into an iron core of a rotator made up of stacked steel sheets can be lessened, so that the problem of the shaft bending due to the press-in fitting process can be eliminated. Furthermore, the document JP 61-65839 U describes that since the taper is formed over the portion of the shaft whose axial length (length in the axis direction) is equal to about ½ to ¼ of the axial length of the shaft hole of the rotator iron core, a clearance is formed between the shaft and the shaft hole at an end side of the rotator iron core and therefore there is no coupling force of the rotator iron core to the shaft.

When the rotor core made up of stacked steel sheets is to be fixed to the rotor shaft by thermal shrink fitting, the shaft hole is expanded in diameter by heating the rotor core, and while this state is maintained, the shaft is inserted through the shaft hole. Then, as the shaft hole reduces in diameter due to the cooling of the rotor core, the inner peripheral portion of the shaft hole is tightened to the rotor shaft so that the rotor core is fixed to the rotor shaft.

In the case where the rotor core is fixed to the rotor shaft by thermal shrink fitting, there is no need for large pressing-in force or a facility for the large pressing-in force, and there is no problem of bending of the rotor shaft or of production of metal powder due to the surface grinding, etc. Thus, this manner of fitting is preferable.

In a rotary electric machine that uses a rotor that is fixed by thermal shrink fitting, there sometimes occurs a phenomenon in which the rotor core tilts to one side in the axis direction. The situation of the phenomenon is illustrated in FIG. 6.

FIG. 6 is a sectional view generally showing a radially half portion of the rotary electric machine 50 with a boundary being a center axis X of the rotor electric machine 50. The rotary electric machine 50 includes a rotor 16 that includes a rotor shaft 12a and a rotor core 14, and a stator 18 disposed around the rotor 16 with a space G of a predetermined size provided between the stator 18 and the rotor 16.

The stator 18 includes a generally cylindrical stator core 20 formed by stacking many annular circular magnetic steel sheets that have been punched out and then firmly connecting the steel sheets together by swaging, welding or the like, and also includes stator coils 22 wound around a plurality of teeth that are protruded radially inward from an inner peripheral portion of the stator core 20 and that are disposed equidistantly in the circumferential direction. Coil end portions 23 that are both end portions of the stator coils 22 in the axis direction are protruded outward from end surfaces of the stator core 20 in the axis direction.

The rotor shaft 12a is formed of a hollow round metal rod member. The rotor shaft 12a has a uniform wall thickness t1 throughout the length thereof in the axis direction.

Furthermore, the rotor shaft 12a is rotatably supported at its two end portions by bearing members (not shown) that are attached to a case (not shown). Then, an end portion 13a of the rotor shaft 12a protruded from the case is connected to a power transmission mechanism 100 that includes rotating objects that include, for example, a gear train, pulleys, etc. Therefore, when the rotary electric machine 50 is used as an electric motor to output motive power from the end portion 13a of the rotor shaft 12a to the power transmission mechanism 100, and when the rotary electric machine 50 is used as an electricity generator so that motive power is input from the power transmission mechanism 100 to the end portion 13a of the rotor shaft 12a, twist torque as shown by an arrow T acts on the end portion 13a of the rotor shaft 12a. Hereinafter, the side in the axis direction where such twist torque occurs will sometimes be termed the twist side or the load side.

The rotor core 14 is also made up of a steel sheet stack obtained by stacking many punched-out circular magnetic steel sheets that each have a center hole and then firmly connecting the steel sheets together by swaging, welding or the like. At the center of the rotor core 14 there is formed a shaft hole 15 that is a through hole formed by the aligned center holes of the steel sheets.

The rotor shaft 12a is inserted through the shaft hole 15 of the rotor core 14. The rotor core 14 is fixed to a predetermined position on the rotor shaft 12a by thermal shrink fitting as described above. Concretely, the rotor core 14 is heated to increase the diameter of the shaft hole 15, and while the radially expanded state of the rotor core 14 is maintained, the rotor shaft 12a is inserted to a predetermined position. Then, the rotor core 14 is cooled to reduce the diameter of the shaft hole 15. Thus, an inner peripheral portion of the shaft hole 15 is tightened onto the rotor shaft 12a so that the rotor core 14 is fixed to the rotor shaft 12a.

Permanent magnets (now shown) are embedded, in a circumferentially equidistant arrangement, within a portion of the rotor core 14 which is adjacent to its outer peripheral surface. The permanent magnets are inserted in the axis direction into magnet insert holes formed in the rotor core 14, and then are fixed by filing the magnet insert holes with a mold resin. Incidentally, if the permanent magnets is demagnetized by the heating at the time of thermal shrink fitting, the permanent magnets may be mounted after the rotor core 14 is fixed to the rotor shaft 12a.

The dimension of the rotor core 14 in the axis direction is the same as the dimension of the stator core 20 in the axis direction. Therefore, when the rotary electric machine 50 is assembled, the rotor core 14 and the stator core 20 are disposed so that the positions of the rotor core 14 and the stator core 20 in the axis direction completely coincide with each other.

However, when the rotary electric machine 50 is driven for use, it sometimes happens that a radially outer portion of the rotor core 14 undergoes a tilting deformation to the twist side as shown in FIG. 6. The present inventors investigated the cause of occurrence of the tilting deformation by observing the deformation of the rotor core 14 and the state of the surface of the rotor shaft 12a. As a result, it has been found that the tilting deformation occurs because buckling occurs in radially inward portions of the stacked steel sheets located in end regions 24a and 24b of the rotor core 14.

It has been revealed that the buckling occurs because the tightening force of the inner peripheral portion of the shaft hole 15 of the thermally fitted rotor core 14 curves or deforms the hollow rotor shaft 12a in a such manner that a middle portion of the rotor shaft 12a is constricted in a radial direction, that is, both end portions of the rotor shaft 12a are relatively expanded in a radial direction, and therefore the surface pressure or the pressing force of the inner peripheral portion of the shaft hole 15 to the rotor shaft 12a becomes excessively large in the axial end regions 24a and 24b of the rotor core 14. This was confirmed by a stress analysis based on a simulation analysis.

Furthermore, it has also turned out that partly because in the end region 24a at the twist side there also occurs the stress resulting from the twist torque T exerted on the rotor shaft 12a, the stress that occurs in the stacked steel sheets in the end region 24a is larger than the stress occurring in the end region 24b on the opposite side.

It is to be noted that in FIG. 6, the tilting deformation of the rotor core 14 is illustrated in an exaggerated manner in order to facilitate the visual understanding of the deformation.

If the tilting deformation caused by the buckling of steel sheets as described above occurs in the rotor core 14, there occurs a shift of a distance s from the position at which the rotor core 14 accurately faces the stator core 20. This leads to an output decline of the rotary electric machine 50.

### SUMMARY OF THE INVENTION

The invention provides a rotor for a rotary electric machine in which the buckling of stacked steel sheets of a rotor core fixed to a rotor shaft by thermal shrink fitting, and also provides a rotary electric machine that uses the rotor.

A rotor for a rotary electric machine in accordance with a first aspect of the invention includes: a rotor shaft; and a rotor core that is made up of a stack of steel stack and that has a shaft hole in a central portion of the stack of steel sheets, and that is tightened and fixed, by thermal shrink fitting, to a periphery of the rotor shaft inserted in the shaft hole. The rotor shaft has a pressing-force distribution adjustment portion that reduces a difference in pressing force that is a reaction force to tightening force of the rotor core occurring during a state in which the rotor core is tightened and fixed to the rotor shaft between a position that corresponds to a middle portion of the rotor core in an axis direction of the rotor core and a position that corresponds to an end region of the rotor core in the axis direction, from an amount of the difference that occurs in a construction in which the pressing-force distribution adjustment portion is not provided.

A rotor for a rotary electric machine in accordance with a second aspect of the invention includes: a rotor shaft; and a rotor core that has a shaft hole in a central portion of the steel sheet stack, and that is tightened and fixed, by thermal shrink fitting, to a periphery of the rotor shaft inserted in the shaft hole, and that is made up of a steel sheet stack. The rotor shaft has a reduced-interference portion at a position that corresponds to an end region of the rotor core in an axis direction of the rotor core, in a contact region of the rotor shaft which contacts an inner peripheral portion of the shaft hole of the rotor core.

A rotary electric machine in accordance with a third aspect of the invention includes a rotor having one of the above-described constructions, and a stator provided around the rotor core with a predetermined space provided between the stator and the rotor core.

According to the rotor for a rotary electric machine in accordance with the aspects of the invention, it is possible to reduce the stress that, after the rotor core made up of a stack of steel sheets is fixed to the rotor shaft, is exerted in stacked steel sheets in an axial end region of the rotor core by a portion of the rotor shaft that is within a contact region of the rotor shaft which contacts an inner peripheral portion of the shaft hole of the rotor core and that corresponds in position to the end region of the rotor core. For example, The rotor shaft has a reduced-interference portion at the position that corresponds to the axial end region of the rotor core within the contact region of the rotor shaft which contacts the inner peripheral portion of the shaft hole of the rotor core. Therefore, the amount of interference by which the inner peripheral portion of the shaft hole of the stacked steel sheets provided in the axial end region tightens the rotor shaft is lessened, so that the effect of reducing the stress can be obtained. Therefore, the rotor core that made up of a stack of steel sheets and that is fitted to the rotor shaft by thermal shrinkage can be restrained from undergoing the tilting deformation in the axis direction due to the buckling of the stacked steel sheets, so that a good output characteristic of the rotary electric machine can be maintained.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a partial sectional view of a rotary electric machine that has a rotor of a rotary electric machine in accordance with an embodiment of the invention, showing only a radially half portion of the rotary electric machine;

FIG. 2 shows a modification of the rotor shaft in a view similar to the view shown in FIG. 1;

FIGS. 3A to 3C are diagrams for describing tilting deformation of a rotor core due to buckling, FIG. 3A being an enlarged view showing a state in which the rotor shaft is in contact with an inner peripheral portion of a shaft hole of a magnetic steel sheet, and FIG. 3B being a diagram showing a state in which the magnetic steel sheet shown in FIG. 3A is buckled, and FIG. 3C being a diagram showing a state in which the rotor core has undergone tilting deformation due to buckling;

FIG. 4 is a diagram showing a state in which a twist-side end region of a rotor core and an opposite-side end region of the rotor core differ from each other in the direction of the tilting deformation resulting from buckling;

FIG. 5 is a graph showing results of an analysis of the stress that acts in the magnetic steel sheets that constitute a rotor core; and

FIG. 6 is a sectional view of a radially half portion of a rotary electric machine, showing a state in which a rotor core made up of a stack of steel sheets undergoes tilting deformation due to buckling when the rotor core is fixed to a rotor shaft by thermal shrink fitting.

### DETAILED DESCRIPTION OF EMBODIMENTS

Embodiments of the invention will be described in detail hereinafter with reference to the accompanying drawings. In the description herein, concrete shapes, materials, numerical values, directions, etc. are mere examples for facilitating the understanding of the invention, and can be appropriately changed in accordance with uses, purposes, specifications, etc. Furthermore, in the description below, in the cases where a plurality of embodiments or modifications and the like are included, it is assumed from the beginning that characteristic portions of the embodiments and the like are appropriately combined for use.

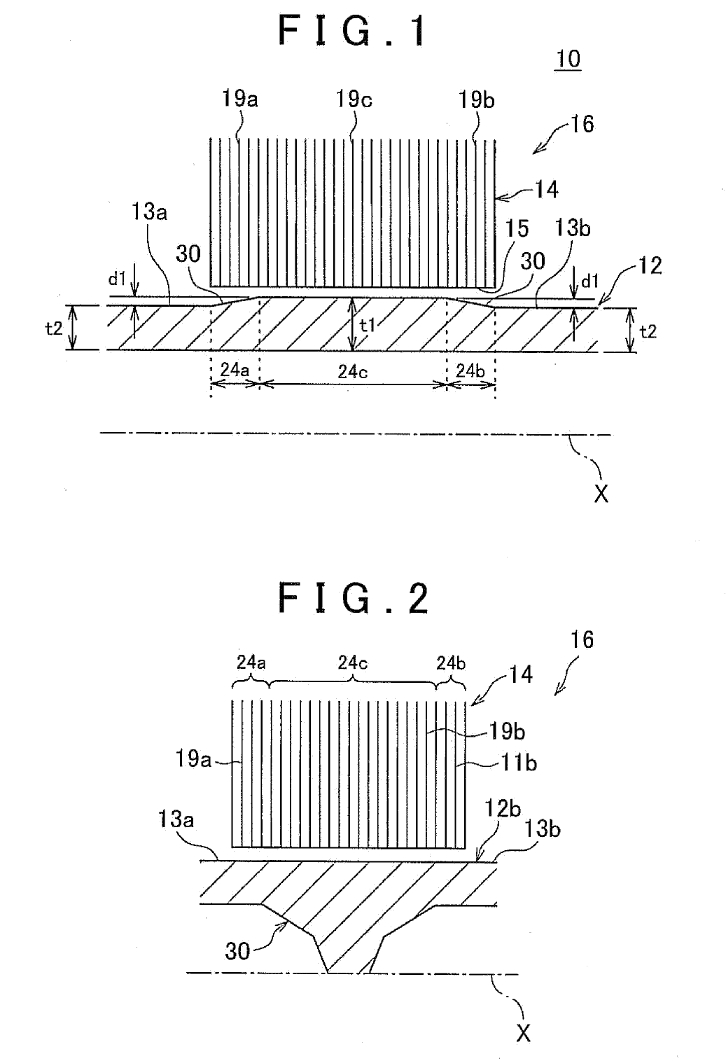

FIG. 1 is a partial sectional view showing only a radially half portion of a rotary electric machine 10 that has a rotor of an embodiment of the invention. The construction of the rotary electric machine 10 is substantially the same as the construction of the rotary electric machine 50, except for a rotor shaft 12. Therefore, the rotor shaft 12 will be mainly described in detail below, and the same members and elements as those of the rotary electric machine 50 will be denoted by the same reference characters and redundant descriptions thereof will be sometimes omitted.

It is to be noted that although in the illustration of FIG. 1, a space is provided between an inner peripheral portion of a shaft hole 15 of a rotor core 14 and a rotor shaft 12 in order to make it easier to see the shape of the shaft easier, the inner peripheral portion of the shaft hole 15 is, in reality, in contact with an outer peripheral surface of the rotor shaft 12 throughout the axial length of the shaft hole 15 of the rotor core 14 fitted to the rotor shaft 12 by thermal shrink fitting.

The rotor 14 of this embodiment includes the rotor shaft 12 formed of a hollow round metal rod member and the rotor core 14 that is fixed to the outer peripheral surface of the rotor shaft 12 by thermal shrink fitting. As for the rotor shaft 12 shown in FIG. 1, a left-side end portion thereof is a twist-side end portion 13a, and a right-side end portion thereof is an opposite-side end portion 13b.

The rotor core 14 is made up of a steel sheet stack formed by stacking many punched-out circular magnetic steel sheets 19a, 19b and 19c that each have a center hole and then firmly connecting the steel sheets together by swaging, welding, etc. At the center of the rotor core 14, the shaft hole 15 is formed which is a through hole formed by the aligned center holes of the magnetic steel sheets 19a, 19b and 19e.

The rotor shaft 12 is inserted through the shaft hole 15 of the rotor core 14. The rotor core 14 is fixed at a predetermined position on the rotor shaft 12 by thermal shrink fitting as mentioned above. Concretely, the rotor core 14 is heated to increase the diameter of the shaft hole 15, and while this state is maintained, the rotor shaft 12 is inserted into the haft hole 15, to a predetermined position. Then, the rotor core 14 is cooled to reduce the diameter of the shaft hole 15. Therefore, an inner peripheral portion of the shaft hole 15 is tightened to the rotor shaft 12 so that the rotor core 14 is fixed to the rotor shaft 12.

The rotor core 14 has an end region 24a at a twist side, an end region 24b at the opposite side (a side opposite to the twist side), and a middle region 24c between the end regions 24a and 24b. The twist-side end region 24a is composed of a plurality of magnetic steel sheets 19a, and the opposite-side end region 24h is composed of a plurality of magnetic steel sheets 19b, and the middle region 24c is composed of a plurality of magnetic steel sheets 19c.

The rotor shaft 12 has reduced-interference portions 30 at positions in a contact region of the rotor shaft which contacts the inner peripheral portion of the shaft hole 15 of the rotor core 14, the positions corresponding to the twist-side end region 24a and the opposite-side end region 24b. Concretely, these reduced-interference portions 30 are each formed by a small-diameter portion of the rotor shaft 12 whose diameter is smaller than the outside diameter of the rotor shaft 12 measured at a position that corresponds to the middle region 24c of the rotor core 14.

Specifically, each of the reduced-interference portions 30 of the rotor shaft 12 is formed as a tapered portion that gradually becomes smaller in diameter toward the outer side in the axis direction (i.e., the side away from the middle region). The tapered portions may be formed so as to have an outside surface that is linear in a longitudinal section as shown in FIG. 1, or may also be formed so as to have a curved outside surface that is convex radially outward.

More specifically, the tapered portions are formed so that a shaft wall thickness t2 of the rotor shaft 12 measured at the outermost positions in the end regions 24a and 24b in the axis direction, that is, the positions that face the axial end surfaces of the rotor core 14, is thinner by a thickness value d1 than a shaft wall thickness t1 of the middle region 24c of the rotor shaft 12. Therefore, the amount of tightening interference provided for the thermal shrink fitting of the rotor core 14 at the time of fixing the rotor core 14 to the rotor shaft 12 is reduced or lessened by a maximum of the thickness value d1 in the end regions 24a and 24b as compared with the middle region 24c. Since the thickness value d1 is the amount of interference reduction in terms of radius, the thickness value corresponding to the amount of interference reduction in terms of diameter is 2×d1.

The thickness value d1 is set by factoring in the force of fixing the rotor core 14 to the rotor shaft 12 (tightening force), the magnitude of the twist torque T that acts in the rotor shaft 12, etc., and can be set to, for example, about ten micrometers to about several tens of micrometers. This degree of dimensional step can easily be formed during the production of the rotor shaft 12 by grinding the outside surface of the shaft by pressing to the rotor shaft 12 a whetstone that has a taper portion while the rotor shaft is rotating. Therefore, the cost raising effect of this structure is ignorably small.

Thus, the rotor shaft 12 in this embodiment is provided with the reduced-interference portions 30 at the positions that correspond to the axis-direction end regions 24a and 24b of the rotor core 14, so that it is possible to reduce the tightening force that the inner peripheral portion of the shaft hole 15 of the rotor core 14 exerts when the rotor core 14 is fitted to the rotor shaft 12 by thermal shrinkage. As a result, the contact surface pressure or pressing force of the inner peripheral portion of the shaft hole 15 to the rotor shaft 12 can be prevented from excessively enlarging at the end regions 24a and 24b of the rotor core 14 and, particularly, the twist-side end region 24a, where twisting stress occurs as well, and therefore the shaft-tightening force of the rotor core 14 can be substantially equalized throughout the length of the rotor core 14 in the axis direction. Therefore, the fixture of the rotor core 14 to the rotor shaft 12 by thermal shrink fitting can be more firmly accomplished, and it is also possible to reduce abrasion, including microscopic crush, tear, etc., of the outside surface of the rotor shaft 12, at the end regions 24a and 24b.

Although in the foregoing description, the reduced-interference portions 30 are formed as tapered portions where the amount of interference reduction gradually increases toward the outer sides in the axis direction, this structure is not limited; for example, each of the reduced-interference portions may be formed with a step height that is equivalent to the interference reduction amount d1 and that is provided at the boundary between the middle region 24c and a corresponding one of the end regions 24a and 24b.

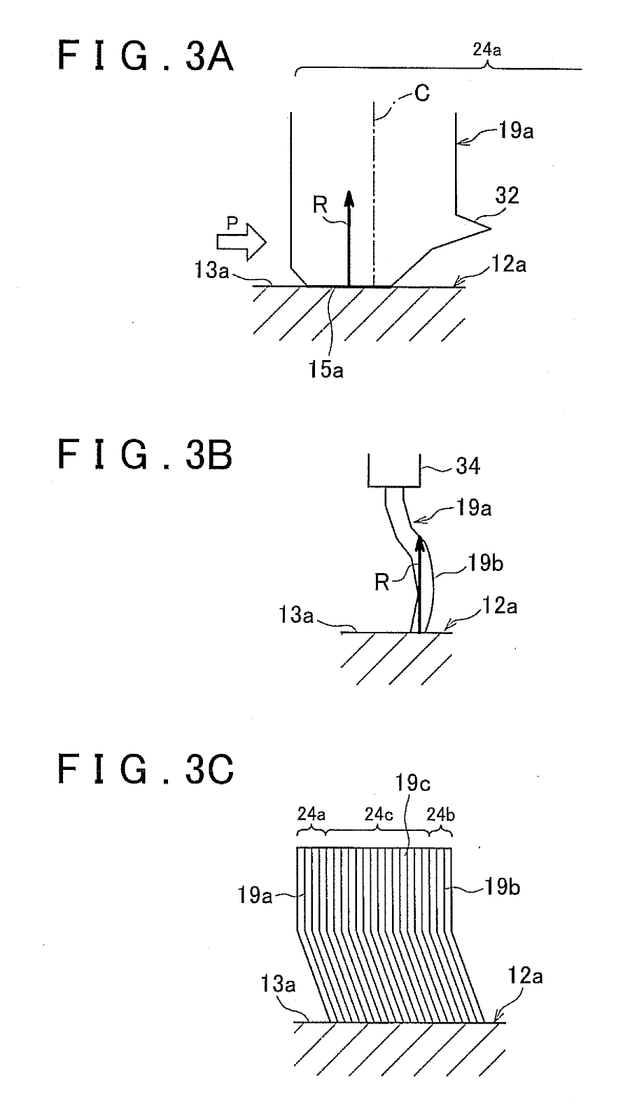

Furthermore, although in the foregoing description, the deflection of the rotor shaft 12 in the axial middle region 24c is absorbed by varying the external shape of the rotor shaft 12, it is also permissible to change the rigidity of the rotor shaft 12 by varying the internal shape of the rotor shaft 12 while having a uniform outside diameter of the rotor shaft 12. For example, a high-rigidity portion may be formed by increasing the wall thickness of the rotor shaft to the radially inner side at positions that correspond to the axial middle region 24c, or a high-rigidity portion may be formed by providing a solid (not hollow) support portion as shown in FIG. 2.

FIGS. 3A to 3C are diagrams for describing tilting deformation of the rotor core 14 due to buckling. FIG. 3A is an enlarged view showing a state in which the rotor shaft 12 is in contact with an inner peripheral portion of the shaft hole 15 (center hole) of a magnetic steel sheet. FIG. 3B is a diagram showing a state in which the magnetic steel sheet shown in FIG. 3A has buckled. FIG. 3C is a diagram showing a state in which the rotor core 14 has undergone tilting deformation due to buckling.

All the magnetic steel sheets 19a, 19b and 19c that constitute the rotor core 14 are stacked with their punching directions coinciding with one another, and are connected and fixed to one another. In the example shown in FIG. 3A, the punching direction of the magnetic steel sheet is shown by an arrow P. In this diagram, only one of the magnetic steel sheets 19a that constitute the twist-side end region 24a is shown in an enlarged view.

As for each of the magnetic steel sheets 19a, when a through-hole 15a that corresponds to the shaft hole 15 is punched out, the through-hole portion ruptures as if it is torn out to a rearward side in the punching direction (to the right side in FIG. 3A). In FIG. 3A, reference numbers 32 denote burr that is formed on an inner peripheral edge portion of the through-hole 15a at the time of rupture. Therefore, the axial width of the contact surface of the inner peripheral portion of the through-hole 15a of the magnetic steel sheet 19a which contacts the rotor shaft 12a is deviated to the forward side in the punching direction (the left side in FIG. 3A) relative to the sheet thickness of the magnetic steel sheet 19a. Hence, a radially outward pressing force R that is a reaction force to the tightening force that occurs at the time of the thermal shrink fitting acts with a deviation from a sheet thickness center line C of the magnetic steel sheet 19a to the load side.

If the pressing force R acting on the magnetic steel sheet 19a with such a deviation as described above becomes excessively large, a radially inner portion of the magnetic steel sheet 19a buckles as shown in FIG. 3B. In this buckling, the magnetic steel sheet 19a first bends rightward and then bends leftward in a view from the through-hole 15a toward the radially outer side. Incidentally, an illustration denoted by reference numbers 34 in FIG. 3B schematically shows that a mold resin that fixes a permanent magnet or a swaged connecting portion between adjacent magnetic steel sheets acts as a catch. The presence of such a catch is considered to make it easier for the buckling to occur.

In the middle region 24c of the rotor core 14, the pressing force from the rotor shaft 12a does not become so great as in the twist-side end region 24a and the opposite-side end region 24b, and therefore the magnetic steel sheets 19e provided in the middle region 24c alone may not bring about the buckling. However, since all the magnetic steel sheets 19a, 19b and 19c are set so that their punching directions coincide with one another, the pressing force from the rotor shaft 12a being deviated from the sheet thickness center line C to the twist side remains the same for the magnetic steel sheets 19c as well, and it can be said that the buckling has occurred or is likely to occur.

Therefore, it is inferred that as shown in FIG. 3C, the entire rotor core 14 undergoes a deformation of tilting to the load side because the magnetic steel sheets 19c positioned in the middle region 24c, which are connected integrally with the magnetic steel sheets 19a by swaging and the mold resin 34, are pulled in the axis direction by the buckling of the magnetic steel sheets 19a in the twist-side end region 24a, and because, likewise, the magnetic steel sheets 19c are pushed in the axis direction by the buckling of the magnetic steel sheets 19b.

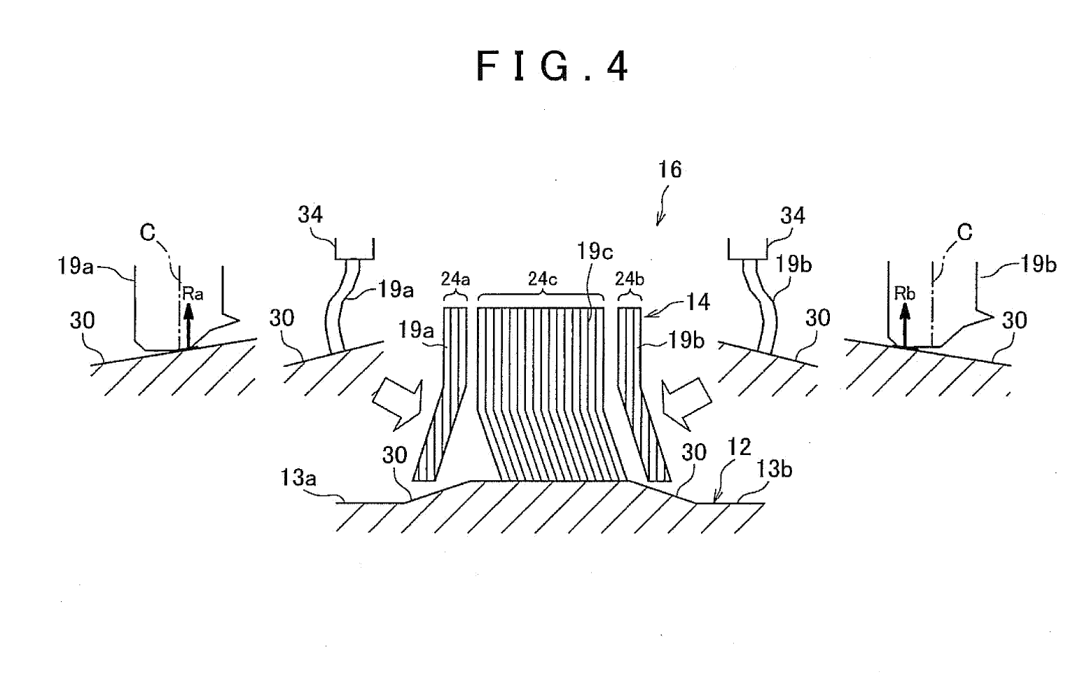

FIG. 4 is a diagram showing a state in which the twist-side end region 24a of the rotor core 14 of the rotor 16 in this embodiment and the opposite-side end region 24b of the rotor core 14 differ from each other in terms of the direction of the tilting deformation resulting from the buckling. Incidentally, the rotor core 14 shown at the center of FIG. 4 have spaces between the middle region 24c and the end regions 24a and 24b in order to make it easier to see and understand the configuration, whereas in reality the magnetic steel sheets 19a, 19b and 19c are closely connected to each other without spaces therebetween.

As for the rotor shaft 12 of the rotor 16 in this embodiment, the reduced-interference portion 30 is formed as a tapered surface at a position that corresponds to the twist-side end region 24a of the rotor core 14. Therefore, with regard to the magnetic steel sheets 19a positioned in the twist-side end region 24a, the pressing force Ra from the contact surface of the rotor shaft 12, that is, the tapered surface, is deviated from the sheet thickness center line C to the right side as shown at the left side in FIG. 4. Due to this, the direction of the tilt resulting from the buckling of the magnetic steel sheets 19a of the twist-side end region 24a is opposite to the direction of the tilt of the magnetic steel sheets 19c and 19b positioned in the middle region 24c and the opposite-side end region 24b. That is, radially outer portions of the magnetic steel sheets 19a of the twist-side end region 24a push the magnetic steel sheets 19c and 19b in the direction that the magnetic steel sheets 19a undergo tilting deformation by buckling toward the middle in the axis direction. Therefore, in a view of the rotor core 14 as a whole, an effect of restraining the tilting deformation caused by the buckling is obtained.

As described above, in the rotor 16 of the embodiment, the rotor shaft 12 has the reduced-interference portions 30 at the positions that are within a contact region of the rotor shaft 12 which contacts the inner peripheral portion of the shaft hole 15 of the rotor core 14 made up of the stack of the magnetic steel sheets 19a, 19b and 19c and that correspond to the end regions 24a and 24b of the rotor core 14. Therefore, in the rotor core 14 fitted to the rotor shaft 12 by the thermal shrink fitting, the amount of interference by which the inner peripheral portion of the shaft hole 15 of the magnetic steel sheets 19a and 19b provided in the end regions 24a and 24b tightens the rotor shaft 12 is lessened. As a result, it is possible to reduce the pressing force in the radial directions and the tensile stress in the circumferential direction that act on the magnetic steel sheets 19a and 19b of the end regions 24a and 24b after the rotor core 14 is fixed. Therefore, the tilting deformation of the rotor core 14 fitted to the rotor shaft 12 by the thermal shrink fitting, which is caused in the axis direction by the buckling of the rotor core 14, can be restrained, and a good output characteristic of the rotary electric machine 10 can be maintained.

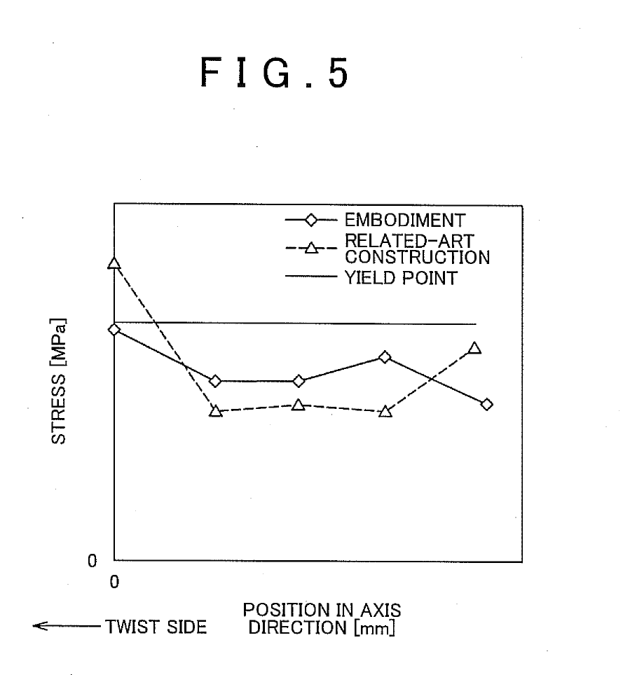

FIG. 5 is a graph showing results of an analysis of the stress that acts in the magnetic steel sheets that constitute the rotor core 14. In this graph, the horizontal axis represents the position (mm) in the direction of the axis of the rotor core 14, and the vertical axis represents the stress force (MPa) that acts in magnetic steel sheets. “0” on the horizontal axis corresponds to the position of the twist-side end surface of the rotor core 14, and the plotted point that is the most rightward in the graph corresponds to the position of the opposite-side end surface of the rotor core 14. The yield point of the magnetic steel sheets is shown by a horizontal solid line.

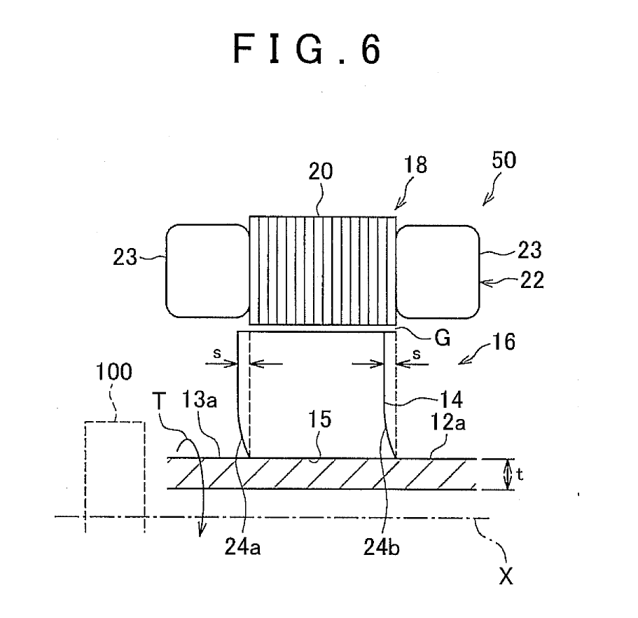

As shown in FIG. 5, in the rotor 16 in accordance with the embodiment, the stresses occurring in the magnetic steel sheets 19c in the axially middle region 24c were larger than in the related-art construction shown in FIG. 6, and the stresses occurring in the magnetic steel sheets 19a and 19b positioned in the end regions 24a and 24b were smaller than in the related-art construction. Thus, it has been verified that in the embodiment, the stresses in the magnetic steel sheets are approximately equalized throughout the length of the rotor core 14 in the axis direction.

However, from the graph of FIG. 5, it can be understood that the stress in the magnetic steel sheets 19a positioned in the twist-side end region 24a was reduced so as to be slightly less than the yield point, but was still at a high level in comparison with the stresses in the magnetic steel sheets 19b and 19c of the other regions 24b and 24c. Therefore, the stress that acts in the magnetic steel sheets 19a may be further reduced by setting the amount of interference reduction of the reduced-interference portion 30 that corresponds to the twist-side end region 24a larger than that of the reduced-interference portion 30 that corresponds to the opposite-side end region 24b. Due to this, the stresses that act in the magnetic steel sheets of the rotor core 14 can be further equalized throughout the length of the rotor core 14 in the axis direction.

Incidentally, the rotor for a rotary electric machine of the invention is not limited to the foregoing embodiment and its modifications, but include various improvements and changes.

For example, although in the foregoing embodiment, the reduced-interference portions 30 are provided at the positions that correspond to the end regions 24a and 24b at both sides of the rotor core 14 in the axis direction, it is also permissible to provide a reduced-interference portion only at a position on one side in the axis direction which corresponds to the twist-side end region 24a. In this construction, too, considerable reduction of the stresses in the magnetic steel sheets 19a can be achieved as can be understood from FIG. 5, so that an effect of restraining the tilting deformation of the rotor core caused by buckling will be obtained.

The reduced-interference portion of the rotor shaft may include a small-diameter portion whose diameter is smaller than the outside diameter of the rotor shaft measured at a position that corresponds to a middle region of the rotor core in the axis direction.

The small-diameter portion may be a tapered portion that gradually becomes smaller in diameter toward the outer side of the rotor core in the axis direction. Furthermore, in the tapered portion, a portion that corresponds to the axial end region of the rotor core may be sloped so that radially outer portions of the magnetic steel sheets provided in the axial end region of the rotor core tilt toward the center of the rotor core in the axis direction due to buckling.

The reduced-interference portion of the rotor shaft may be provided corresponding to each of two end regions of the rotor core in the axis direction. Furthermore, the reduced-interference portion at a side where the rotor shaft is connected to a power transmission mechanism may be designed so as to have a larger amount of interference reduction than the reduced-interference portion provided at the side opposite to the side of connection to the power transmission mechanism.

What is claimed is:

1. A rotor for a rotary electric machine, comprising:
a rotor shaft; and
a rotor core that is made up of a stack of steel sheets, and that has a shaft hole in a central portion of the stack of steel sheets, and that is tightened and fixed, by thermal shrink fitting, to a periphery of the rotor shaft inserted in the shaft hole, wherein
the rotor shaft has a pressing-force distribution adjustment portion that reduces a difference in pressing force that is a reaction force to tightening force of the rotor core occurring during a state in which the rotor core is tightened and fixed to the rotor shaft between a position that corresponds to a middle portion of the rotor core in an axis direction of the rotor core and a position that corresponds to an end region of the rotor core in the axis direction.

2. The rotor according to claim 1, wherein
the pressing-force distribution adjustment portion is a reduced-interference portion provided at the end region of the rotor core in the axis direction, in a contact region of the rotor shaft which contacts an inner peripheral portion of the shaft hole of the rotor core.

3. The rotor according to claim 2, wherein
the reduced-interference portion of the rotor shaft includes a small-diameter portion whose diameter is smaller than an outside diameter of the rotor shaft measured at the position that corresponds to the middle region of the rotor core in the axis direction.

4. The rotor according to claim 3, wherein
the small-diameter portion is a tapered portion that gradually becomes smaller in diameter toward an outer side of the rotor core in the axis direction.

5. The rotor according to claim 4, wherein
in the tapered portion, a portion that corresponds to the end region of the rotor core in the axis direction is sloped so that radially outer portions of stacked steel sheets provided in the end region of the rotor core in the axis direction tilt toward a middle of the rotor core in the axis direction due to buckling.

6. The rotor according to claim 2, wherein
the reduced-interference portion of the rotor shaft is provided corresponding to each of the end regions provided at two opposite sides of the rotor core in the axis direction.

7. The rotor according to claim 6, wherein
the reduced-interference portion at a side where the rotor shaft is connected to a power transmission mechanism has a larger amount of interference reduction than the reduced-interference portion provided at a side opposite to the side where the rotor shaft is connected to the power transmission mechanism.

8. The rotor according to claim 1, wherein
the pressing-force distribution adjustment portion is a thick-walled portion which is provided at the position that corresponds to the middle region of the rotor shaft in the axis direction and whose wall thickness is radially inwardly added to.

9. The rotor according to claim 1, wherein
the pressing-force distribution adjustment portion is a support portion that is solid and that is provided at the position that corresponds to the middle region of the rotor shaft in the axis direction.

10. A rotary electric machine comprising:
a rotor according to claim 1; and
a stator provided around the rotor core with a predetermined space provided between the stator and the rotor core.

11. A rotor for a rotary electric machine, comprising:
a rotor shaft; and
a rotor core that is made up of a stack of steel sheets, and that has a shaft hole in a central portion of the stack of steel sheets, and that is tightened and fixed, by thermal shrink fitting, to a periphery of the rotor shaft inserted in the shaft hole, wherein
the rotor shaft has a reduced-interference portion at a position that corresponds to an end region of the rotor core in an axis direction of the rotor core, in a contact region of the rotor shaft which contacts an inner peripheral portion of the shaft hole of the rotor core.

12. The rotor according to claim 11, wherein
the reduced-interference portion of the rotor shaft includes a small-diameter portion whose diameter is smaller than an outside diameter of the rotor shaft measured at the position that corresponds to the middle region of the rotor core in the axis direction.

13. The rotor according to claim 12, wherein
the small-diameter portion is a tapered portion that gradually becomes smaller in diameter toward an outer side of the rotor core in the axis direction.

14. The rotor according to claim 13, wherein
in the tapered portion, a portion that corresponds to the end region of the rotor core in the axis direction is sloped so that radially outer portions of stacked steel sheets provided in the end region of the rotor core in the axis direction tilt toward a middle of the rotor core in the axis direction due to buckling.

15. The rotor according to claim 11, wherein
the reduced-interference portion of the rotor shaft is provided corresponding to each of the end regions provided at two opposite sides of the rotor core in the axis direction.

16. The rotor according to claim 15, wherein
the reduced-interference portion at a side where the rotor shaft is connected to a power transmission mechanism has a larger amount of interference reduction than the reduced-interference portion provided at a side opposite to the side where the rotor shaft is connected to the power transmission mechanism.

17. A rotary electric machine comprising:
a rotor according to claim 11; and
a stator provided around the rotor core with a predetermined space provided between the stator and the rotor core.
